(19) United States
(12) Patent Application Publication
(10) Pub. No.: US 2026/0368626 A1
(43) Pub. Date: Nov. 19, 2026

(54) SYSTEM AND METHOD USING MACHINE LEARNING TO MITIGATE NOISE, VIBRATION, AND HARSHNESS OF AN ELECTRIC MOTOR

(71) Applicant: Hanon Systems EFP CANADA LTD, Concord (CA)

(72) Inventor: Harpreet Singh, Concord (CA)

(21) Appl. No.: 19/209,911

(22) Filed: May 16, 2025

(51) Int. Cl. G06N 20/00; G06N 5/022

(52) U.S. Cl. CPC G06N 20/00; G06N 5/022

(57) ABSTRACT

Systems and methods are disclosed that use machine learning to reduce a noise, vibration, and harshness level of an electric motor. The system comprises a computing system in communication with one or more sensors configured to detect and/or measure one or more parameters associated with the electric motor. The computing system is configured to: receive, via the at least one communication network, input data comprising the one or more parameters detected and/or measured by the one or more sensors; train, via machine learning and using a training data set, a machine learning model configured to identify at least one relationship between the one or more parameters and at least one noise, vibration, and harness characteristic of the electric motor; predict, via the computing system, an output using the trained machine learning model; and control, via the computing system, the electric motor based on the predicted output.

### FIELD

This invention relates generally to the field of electric motors, and more particularly to systems and methods using machine learning to mitigate noise, vibration, and harshness of an electric motor.

### BACKGROUND

Noise, vibration, and harshness (NVH) is a critical area of concern in electric motors, especially as they are increasingly used in applications like electric or hybrid vehicles, where quiet operation and smooth performance are required. NVH refers to the combined effects of unwanted sound, mechanical oscillations, and the human perception of these disturbances. In electric motors, managing NVH is more difficult than in internal combustion engines because there is no engine to noise to mask other sounds, making motor-related disturbances more noticeable.

Common sources of NVH in electric motors are electromagnetic forces, mechanical issues, and aerodynamic noise. The electromagnetic forces originate from the interaction of magnetic fields between the stator and rotor of the electric motor. Forces like radial and tangential magnetic pulls and slight deformation of material under magnetic fields create vibrations. For example, a high-pitched whine often results from these forces having resonant frequencies in the motor structure. The frequencies may depend on motor speed and design (e.g., a 3000 RPM motor may produce a 100 HZ hum from twice the supply frequency). Some NVH issues, like uneven air gaps causing extra magnetic forces, sap energy as heat or sound instead of mechanical output.

Vibrations may also be attributed to mechanical issues such as imbalances in the rotor, worn bearings, or misalignment with the load. These tend to scale with motor speed and load, so an electric motor under strain may growl or thud. The vibrations typically make the vehicle feel less refined or less comfortable to control. Additionally, the vibrations loosen components over time. As such, an electric motor with high NVH may fail sooner.

Aerodynamic noise may also contribute NVH. Cooling fans or ventilation systems cause windage noise, especially in high-speed electric motors. This results in a whooshing or whistling sound, independent of load but dependent on motor speed.

Accordingly, it would be desirable to design a system and method that uses machine learning to reduce noise, vibration, and harshness of an electric motor without increasing costs and design complexity, while maintaining system performance.

### SUMMARY

In concordance and agreement with the presently described subject matter, a system and method that uses machine learning to reduce noise, vibration, and harshness of an electric motor without increasing costs and design complexity, while maintaining system performance, have been newly designed. Shortcomings of the prior art are overcome and additional advantages are provided through the systems and the methods in accordance with the present disclosure.

It is an objective of the presently described subject matter to reduce NVH of electric pumps powered by electric motors through a machine learning approach. By utilizing operational data from a field-oriented control of the electric motor, the system can generate real-time anti-noise signals to cancel unwanted noise and/or dynamically adjust one or more of parameters of the electric motor to minimize ripple and harmonics. This software-only solution eliminates the need for additional hardware (e.g., microphones, speakers, accelerometers), reducing costs and complexity, which maintaining adaptability to varying operating conditions. It seamlessly integrates with existing designs, enhancing both performance and efficiency in automotive applications.

In one embodiment, an electric motor control system using machine learning, comprises: an electric motor comprising a stator and a rotor; and a computing system including one or more processing devices in communication with one or more sensors via at least one communication network, the one or more sensors configured to detect and/or measure one or more parameters associated with the electric motor, wherein the computing system executes computer-readable instructions, and wherein, upon execution of the computer-readable instructions, the computing system is configured to: receive, via the at least one communication network, input data comprising the one or more parameters detected and/or measured by the one or more sensors; train, via machine learning and using a training data set, a machine learning model configured to identify at least one relationship between the one or more parameters and at least one noise, vibration, and harness characteristic of the electric motor, wherein the training data set utilized during the training of the machine learning model comprises the input data; predict, via the computing system, an output using the trained machine learning model, wherein the predicted output comprises at least one anti-noise signal and/or at least one adjustment to one or more specific parameters of the electric motor; and control, via the computing system, the electric motor based on the predicted output to decrease a noise, vibration, and harshness level of the electric motor.

In another embodiment, a method of controlling an electric motor, comprises: providing an electric motor comprising a stator and a rotor; providing a computing system including one or more processing devices in communication with one or more sensors via at least one communication network, the one or more sensors configured to detect and/or measure one or more parameters associated with the electric motor, and wherein the computing system is configured to execute computer-readable instructions; receiving, via the at least one communication network, input data comprising the one or more parameters detected and/or measured by the one or more sensors; training, via machine learning and using a training data set, a machine learning model configured to identify at least one relationship between the one or more parameters and at least one noise, vibration, and harness characteristic of the electric motor, wherein the training data set utilized during the training of the machine learning model comprises the input data; predicting, via the computing system, an output using the trained machine learning model, wherein the predicted output comprises at least one anti-noise signal and/or at least one adjustment to one or more specific parameters of the electric motor; and controlling, via the computing system, the electric motor based on the predicted output to decrease a noise, vibration, and harshness level of the electric motor.

As aspects of some embodiments, the machine learning uses at least one neural network.

As aspects of some embodiments, the machine learning uses supervised learning.

As aspects of some embodiments, the one or more parameters includes a phase current of the electric motor.

As aspects of some embodiments, the one or more parameters includes a phase voltage of the electric motor.

As aspects of some embodiments, the one or more parameters includes a back-electromotive force of the electric motor.

As aspects of some embodiments, the one or more parameters includes a speed of the electric motor.

As aspects of some embodiments, the one or more parameters includes a supply voltage of the electric motor.

As aspects of some embodiments, the one or more parameters includes a pulse width modulation duty cycle of the electric motor.

As aspects of some embodiments, the one or more parameters includes at least one load condition of the electric motor.

As aspects of some embodiments, the one or more parameters includes a A-weighted decibel (dBA) of the electric motor.

As aspects of some embodiments, upon execution of the computer-readable instructions, the computing system is further configured to validate the machine learning model.

As aspects of some embodiments, upon execution of the computer-readable instructions, the computing system is further configured to indicate, via a feedback loop, for each predicted output whether the at least one adjustment to the one or more specific parameters decreases the noise, vibration, and harness level of the electric motor.

As aspects of some embodiments, the at least one anti-noise signal comprises harmonic cancellation by injecting counter-frequencies in electrical signals.

As aspects of some embodiments, the one or more specific parameters of the electric motor are a subset of the input data.

As aspects of some embodiments, the one or more specific parameters of the electric motor are limited to operational parameters thereof.

As aspects of some embodiments, the one or more specific parameters of the electric motor includes a current and/or a voltage thereof to smooth torque ripple thereof.

As aspects of some embodiments, the one or more specific parameters of the electric motor includes a phase timing thereof to decrease a resonance.

As aspects of some embodiments, the electric motor is disposed in an electric pump of a vehicle.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

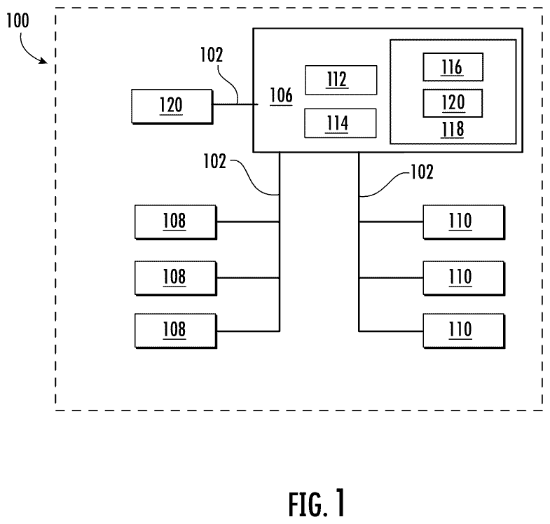

FIG. 1 is a schematic block diagram illustrating a system and environment for implementing a method for reducing noise, vibration, and harshness of an electric motor in accordance with an embodiment of the presently described subject matter;

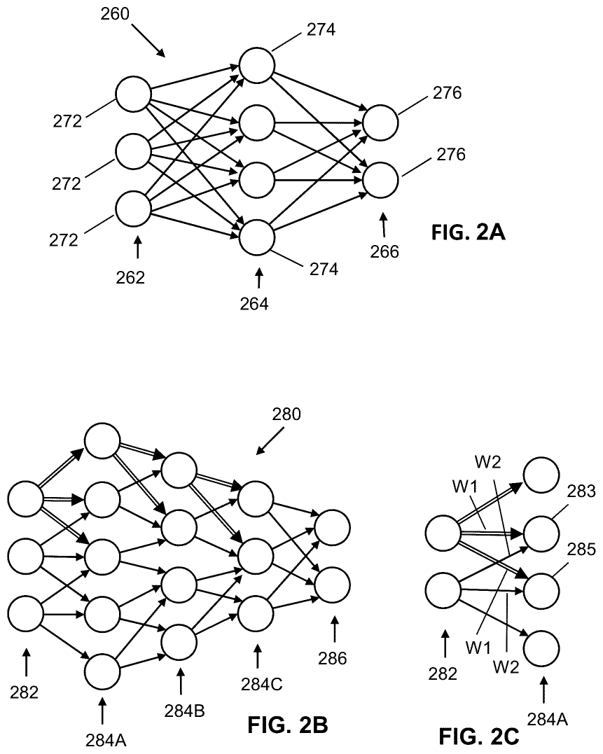

FIG. 2A is a diagram of a feedforward network, according to at least one embodiment, utilized in machine learning;

FIG. 2B is a diagram of a convolution neural network, according to at least one embodiment, utilized in machine learning;

FIG. 2C is a diagram of a portion of the convolution neural network of FIG. 2B, according to at least one embodiment, illustrating assigned weights at connections or neurons;

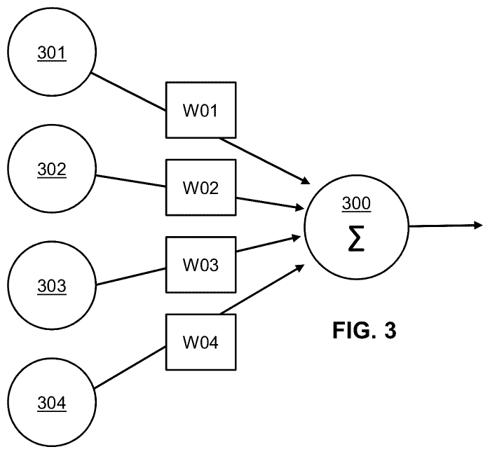

FIG. 3 is a diagram representing an exemplary weighted sum computation in a node in an artificial neural network;

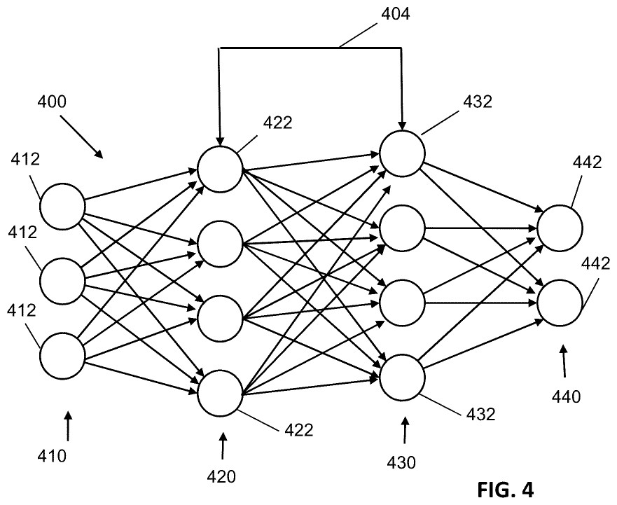

FIG. 4 is a diagram of a Recurrent Neural Network RNN, according to at least one embodiment, utilized in machine learning;

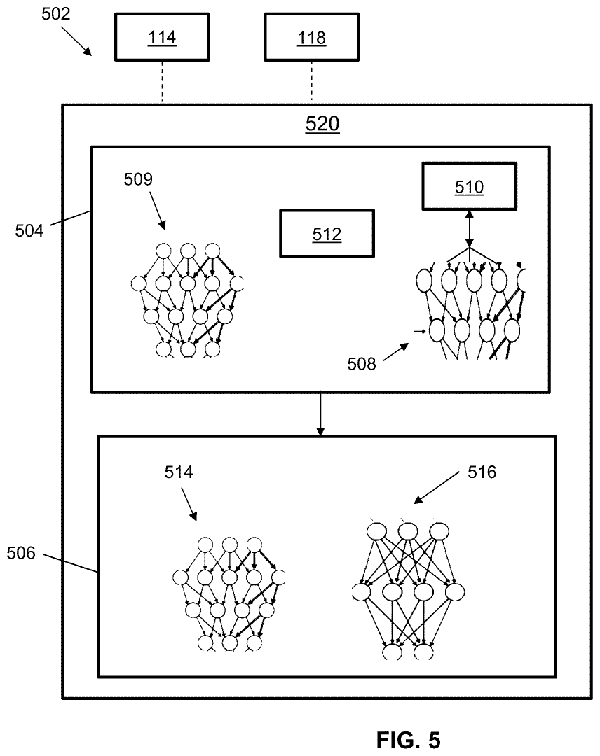

FIG. 5 is a schematic logic diagram of an artificial intelligence program including a front-end and a back-end algorithm;

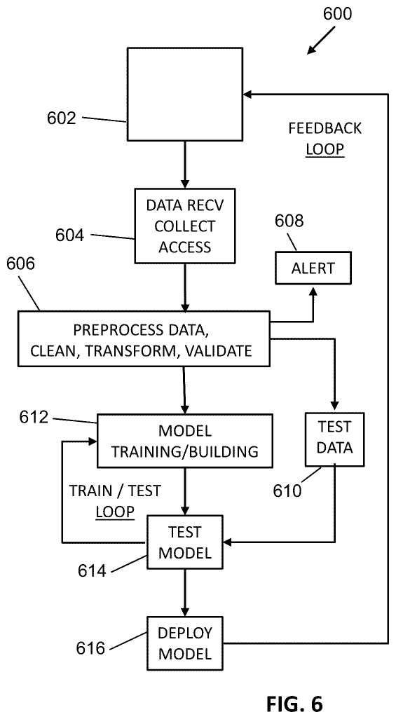

FIG. 6 is a flow diagram illustrating a method, according to at least one embodiment, of model development and deployment by machine learning;

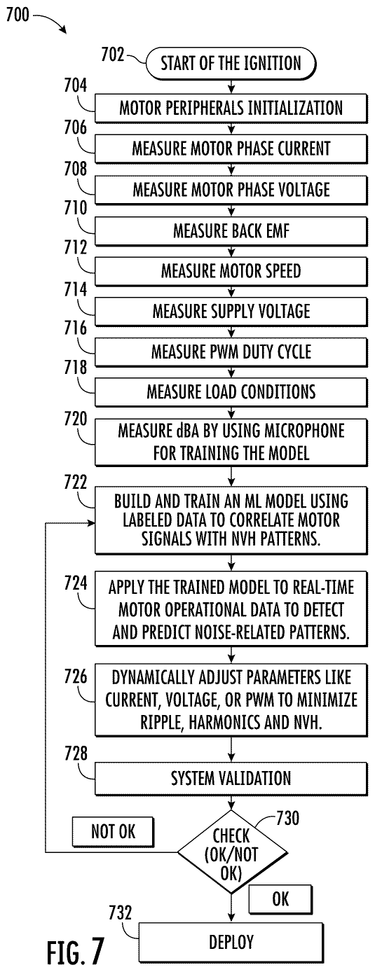

FIG. 7 is a flow diagram illustrating an exemplary method of implementing at least one machine learning program for reducing noise, vibration, and harshness of an electric motor according to the presently described subject matter; and

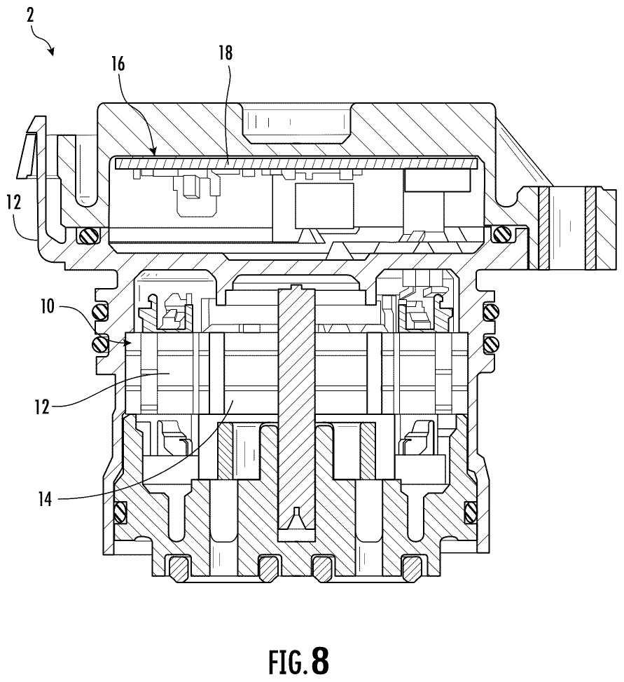

FIG. 8 is a cross-sectional view of an exemplary electric pump according to an embodiment of the presently described subject matter.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way, but may also be configured in ways that are not listed.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

According to embodiments of the present disclosure a local interconnect network (LIN) and a controller area network (CAN), such as a data bus or “CAN bus”, each of which corresponds to a communication network in a vehicle, are briefly described hereinafter.

LIN communication corresponds to a communication scheme mainly used for data transmission among at least one electronic control unit (ECU) and one or more sensors. It typically connects less critical devices, such as sensors and actuators, to a central control unit, efficiently transmitting data with minimal resources. In some instances, LIN communication has a simple protocol structure, may be configured as a 12V single wire bus, and may operate based on a master-slave principle.

CAN communication is mainly used for data transmission between various ECUs of a vehicle system to facilitates efficient data exchange within the vehicle, enabling seamless integration and functionality of different components. In certain CAN communications, data may be transmitted through a CAN_H line and a CAN_L line coated to be shielded, and mutually twisted. CAN communication may operate based on a multi-master principle in which a plurality of ECUs perform master functions in a master/slave system. Oftentimes, the LIN complements CAN by handling lower-speed communications, typically managing non-critical functions.

FIG. 1 illustrates a block diagram of a system 100 in a vehicle according to an embodiment of the present invention. The system 100 may utilize one or more communication networks 102 (e.g., CAN, LIN, etc.), which allow communication between many vehicle systems and sub-systems, such as the vehicle engine, the transmission, braking system, etc. It is understood that any other suitable communication means, methods, and protocols may be utilized, such as Ethernet, for example. The present disclosure and teachings described herein provide for an electric motor 10 used in the vehicle. The electric motor 10 may comprise a stator 12 and a rotor 14, and an electrical controller 16 comprising a printed circuit board (PCB) 18 and an appropriate electrical connector (not depicted) for electrically coupling the electric motor 10 to a source of electrical current power (such as a battery or similar type device). In an exemplary embodiment illustrated in FIG. 8, the electric motor 10 may be used in an electric pump 2 of the vehicle.

The system 100 further includes a controller or computing system 106 in communication with one or more ECUs 108 and/or one or more sensors 110 via the communication networks 102. In some embodiments, at least one of the one or more sensors 110 may be disposed internally within the electric motor 10 and/or the electric pump 2 powered by the electric motor 10. Additionally or alternatively, at least one of the one or more sensors 110 may be located external to the electric motor 10 and/or the electric pump 2. The computing system 106 may include at least one processing device 112 and at least one memory device 114 (e.g., random access memory (RAM), read-only memory (ROM), and the like) for storing computer-readable instructions 116 and may be configured to receive input data (i.e., signals representative of sensed parameters) from the one or more sensors 110 located throughout the vehicle. In some embodiments, the computing system 106, including the at least one processing device 112 and the at least one memory device 114, may receive an input data from various sensors 110 associated with the electric motor 10, which are configured to detect and measure certain parameters thereof.

The illustrated computing system 106 further includes a storage device 118 including at least one non-transitory storage medium, such as a microdrive, for long-term, intermediate-term, and short-term storage of the computer-readable instructions 116 for execution by the at least one processing device 112. For example, the instructions 116 can include instructions for an operating system and various applications or programs. The storage device 118 can store various other data 120, which can include, as non-limiting examples, cached data, data received from other devices, and other data preferred or required or related to any or all of the applications or programs.

The at least one processing device 112, in various examples, can operatively perform calculations, can process instructions for execution, and can manipulate information. The at least one processing device 112 can execute machine-executable instructions stored in the storage device 118 and/or the at least one memory device 114 to thereby perform methods and functions as described or implied herein. The at least one processing device 112 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Preferably, the one or more sensors 110 may be configured to detect and measure a phase current of the electric motor 10, a phase voltage of the electric motor 10, a back-electromotive force of the electric motor 10, a speed of the electric motor 10, a supply voltage of the electric motor 10, a pulse width modulation (PWM) duty cycle of the electric motor 10, one or more load conditions of the electric motor 10, and/or a A-weighted decibel (dBA) of the electric motor 10 and/or the electric pump 2. A main controller or computing system 120 may be in communication with the computing system 106, one or more of the ECUs 108, and/or one or more of the sensors 110 via the communication networks 102.

In preferred embodiments, the computing device 106 may be further configured to reduce a noise, vibration, and harshness (NVH) level by controlling the electric motor 10 using artificial intelligence and/or machine learning in accordance with the present disclosure.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a sensor belongs. Additionally or alternatively, the machine learning algorithm may include one or more regression algorithms (e.g., linear and/or non-linear) configured to output a numerical value given an input. Further, the machine learning may include one or more pattern recognition algorithms, e.g., a module, subroutine or the like. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An artificial neural network (ANN), also known as a feedforward network, may be utilized, e.g., an acyclic graph with nodes arranged in layers. A feedforward network (see, e.g., feedforward network 260 referenced in FIG. 2A) may include a topography with a hidden layer 264 between an input layer 262 and an output layer 266. The input layer 262, having nodes commonly referenced in FIG. 2A as input nodes 272 for convenience, communicates input data, variables, matrices, or the like to the hidden layer 264, having nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers, e.g., an activation function implemented between the input data communicated from the input layer 262 and the output data communicated to the nodes 276 of the output layer 266. It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 280 in FIG. 2B. As in the basic feedforward network 260 of FIG. 2A, the illustrated example of FIG. 2B has an input layer 282 and an output layer 286. However, where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing input data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

An example for a Recurrent Neural Network RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate input data from at least one node 432 from the second hidden layer 430 to at least one node 422 of the first hidden layer 420. It should be appreciated that two or more and up to all of the nodes of a subsequent layer may provide or communicate a parameter or other data to a previous layer of the RNN 400. Moreover and in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them, i.e., nodes of nonsequential layers of the RNN 400.

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine learning program may include a relatively large number of layers, e.g., three or more layers, and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input output transformations and may include, according to various embodiments, a backpropagation algorithm. According to various embodiments, deep neural networks may be configured to classify a dataset. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, scientific data, and the like.

Referring now to FIG. 5 and some embodiments, an AI program 502 may include a front-end algorithm 504 and a back-end algorithm 506. The artificial intelligence program 502 may be implemented on an AI processing device 520, such as the at least one processing device 112 and/or a dedicated processing device. The instructions associated with the front-end algorithm 504 and the back-end algorithm 506 may be stored in an associated memory device and/or storage device of the system communicatively coupled to the AI processing device 520, as shown. Additionally or alternatively, the system may include one or more memory devices and/or storage devices (represented by memory and/or storage devices 114, 118 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

Additionally or alternatively, the front-end program 504 can include one or more AI algorithms 510, 512 (e.g., statistical models or machine learning programs such as decision tree learning, associate rule learning, recurrent artificial neural networks, support vector machines, and the like). In various embodiments, the front-end program 504 may be configured to include built in training and inference logic or suitable software to train the neural network prior to use (e.g., machine learning logic). For example, a CNN 508 and/or AI algorithm 510 may be used for input categorization and/or support vector training. In some embodiments and within the front-end program 504, an output from an AI algorithm 510 may be communicated to a CNN 508 or 509, which processes the data before communicating an output from the CNN 508, 509 and/or the front-end program 504 to the back-end program 506. In various embodiments, the back-end network 506 may be configured to implement input and/or model classification, and the like. For instance, the back-end network 506 may include one or more CNNs (e.g, CNN 514) or dense networks (e.g., dense networks 516), as described herein.

For instance and in some embodiments of the AI program 502, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known, e.g., a mix of labeled and unlabeled data having the same distribution.

In some embodiments, the AI program 502 may be accelerated via a machine learning framework 520 (e.g., hardware). The machine learning framework may include an index of basic operations, subroutines, and the like (primitives) typically implemented by AI and/or machine learning algorithms. Thus, the AI program 502 may be configured to utilize the primitives of the framework 520 to perform some or all of the calculations required by the AI program 502. Primitives suitable for inclusion in the machine learning framework 520 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

FIG. 6 is a flow chart representing a method 600, according to at least one embodiment, of model development and deployment by machine learning. The method 600 represents at least one example of a machine learning workflow in which steps are implemented in a machine learning project.

In step 602, the machine-learning workflow is initiated. This may represent requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further data input or oversight via a feedback loop.

In step 604, data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated. Step 606 can include data validation, which focuses on confirming that the statistics of the ingested data are as expected, such as that data values are within expected numerical ranges, that data sets are within any expected or required categories, and that data comply with any needed distributions such as within those categories. Step 606 can proceed to step 608 to automatically alert the system 100 if any anomalies are detected in the data, thereby pausing or terminating the process flow until corrective action is taken.

In step 610, training test data such as a target variable value is inserted into an iterative training and testing loop. In step 612, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which decision-making, forecasting, predictive modelling, and/or automated suggestion generation serve as non-limiting examples.

The present invention relates to the creation of a predictive model for reducing NVH of an electric motor 10 based on the training of a machine learning program. The machine learning program of the present invention is described hereinafter as utilizing the data sets associated with parameters of the electric motor 10. As mentioned hereinabove, each of the parameters of the electric motor 10 may be actual measurements obtained during operation of the electric motor 10 under various load conditions. Certain interactions between the parameters of the electric motor 10 and one or more NVH characteristics may be monitored and recorded by the computing system 106, as described in greater detail herein.

FIG. 7 illustrates a method 700 of controlling an electric motor 10 according to the present disclosure. In particular, the method 700 uses machine learning and the parameters of the electric motor 10 received from the sensors 110 to reduce NVH of the electric motor 10.

Referring to FIG. 7, the method 700 commences at a start of ignition of the vehicle at step 702 and where, upon execution of the computer-readable instructions 116, the computing device 106 is configured to perform the method 700 described herein. At step 704, peripherals of the electric motor 10 are initialized. Thereafter, at step 706, one or more of the sensors 110 detects and measures the phase current of the electric motor 10. At step 708, one or more of the sensors 110 detects and measures the phase voltage of the electric motor 10. At step 710, one or more of the sensors 110 detects and measures the back-electromotive force of the electric motor 10. At step 712, one or more of the sensors 110 detects and measures the speed of the electric motor 10. At step 714, one or more of the sensors 110 detects and measures the supply voltage of the electric motor 10. At step 716, one or more of the sensors 110 detects and measures the pulse width modulation (PWM) duty cycle of the electric motor 10. At step 718, one or more of the sensors 110 detects and measures at least one of the load conditions of the electric motor 10. At step 720, one or more of the sensors 110 detects and measures, via an audio receiver such as a microphone, the A-weighted decibel (dBA) of the electric motor 10 and/or the electric pump 2. It should be appreciated that more or less parameters may be detected and measured by the one or more sensors 110 if desired. It is also understood that one or more of the steps 702 through 720 may be executed consecutively, simultaneously, and/or substantially simultaneously as another one or more of the steps 702 through 720, and/or repeated as needed.

Each of the parameters detected and measured by the one or more sensors 110 (also referred to herein as “input data”) is transmitted to and received by the computing system 106, where the one or more of the parameters are processed by the at least one processing device 112. For example, the at least one processing device 112 executes the computer-readable instructions to compare the parameters received from the one or more of the sensors 110 to one or more predetermined threshold values.

The input data may be in the form of the data 120 stored to the storage device 118 of the computing system 106 as utilized for carrying out the functions of the machine learning program as described herein. The input data may originate from various different sources including the one or more sensors 110, interactions and relationships of the parameters of the electric motor 10 with the NVH characteristics, and/or one or more external sources or systems.

The present invention relies upon the computing system 106 having access to the input data in order to train the machine learning program and subsequently utilize the predictive model generated thereby. The computing system 106 may collect the input data regarding the parameters of the electric motor 10 and the interactions and relationships of the parameters of the electric motor 10 with the NVH characteristics by directly receiving signals from the one or more sensors 110.

As used in various examples hereinafter, an input data set may include at least one data entry related to one or more of the parameters of the electric motor 10. The input data set may also include at least one data entry related to the interactions and relationships of the parameters of the electric motor 10 with the NVH characteristics. It should be appreciated that the input data set associated with the electric motor 10 may include any combination of the data described as being available to the computing system 106 herein while remaining within the scope of the present invention.

The present invention relates to various different machine learning processes carried out by the computing system 106 and suitable for predicting NVH patterns based on the input data set thereof at the time of the desired prediction. The machine learning program may utilize any of the processes described herein, alone or in combination, while remaining within the scope of the present invention. The described processes are drawn towards reducing NVH of the electric motor 10 and/or the electric pump 2 based on the predictive capabilities of a corresponding predictive model generated by the machine learning program.

At step 722, the system 100, preferably the computing system 106 and/or the at least one processing device 112, builds and trains the machine learning model using labeled data to correlate signals of the electric motor 10 with NVH patterns. For example, the machine learning model learns complex interactions and relationships between the input data of the electric motor 10 and the NVH characteristics.

In some embodiments, the system 100 builds the machine learning model using differential equations that relate to the operation of the electric motor 10. For example, the dynamic behavior of system 100 may be represented by the following equation:

$$V ( t ) = {R}_{s} * I ( t ) + \frac{d Ψ ( t )}{dt} + E ( t )$$

where,
V(t): voltage vector applied to the electric motor phases;
Rₛ: stator winding resistance;
I(t): current vector through the electric motor windings;
ψ(t): flux linkage in the electric motor, which varies with rotor position; and
E(t): back-electromotive force of the electric motor.

The electric motor 10 produces torque T (t), which relates to the current and the back-electromotive force of the electric motor 10 as indicated in the following equation:

T(t)=I(t)\hat{ }T*ψ(t)

This torque of the electric motor 10 may be affected by mechanical vibrations and noise, which can be represented by a disturbance or noise term n(t), leading to an undesired noise component in the acoustic output of the electric motor 10.

In certain embodiments, the system 100, preferably the computing system 106 and/or the at least one processing device 112, models the noise component n(t) using the machine learning model. A total electric motor response, including noise, may be represented by the following equation:

y(t)=f(x(t))+n(t)

where,
y(t): observed electric motor behavior including noise;
f(x(t)): electric motor behavior modeled through control inputs and system dynamics; and
n(t): noise or vibration.

Together, these equations may be used to manage the performance of the electric motor 10 when implementing the machine learning model and program for reducing the NVH of the electric motor 10 and/or the electric pump 2.

A training data set may be utilized in performing the training of the associated predictive model of the machine learning program. The training data set may comprise any subset of the described types of input data described herein with respect to the electric motor 10, so long as the input data set forming the training data set includes data therein indicative of the parameters of the electric motor 10 and the NVH characteristics as described herein. The training data set may include the use of all entries of the input data set associated with the electric motor 10 or may include the use of only specific data entries associated with the parameters of the electric motor 10, such as only data related to certain parameters and/or certain NVH characteristics. The training data set may also include each of the data entries within certain limitations such as the parameters being limited to those having occurred within a given time frame.

In some embodiments, the machine learning program may utilize supervised learning according to any of the supervised learning processes or tools disclosed herein. The supervised learning process may include the data relating to at least one anti-noise signal and/or at least one adjustment to one or more of the parameters of the electric motor being labeled as an output while the input data forming the training data are labeled as inputs into the corresponding model. The anti-noise signal may comprise harmonic cancellation by injecting counter-frequencies in electrical signals and/or the adjustment to the one or more specific parameters of the electric motor 10 may include modulating the current and/or the voltage thereof to smooth torque ripple and/or controlling the phase timing of the electric motor 10 to minimize resonance.

In some embodiments, the specific parameters of the electric motor 10 subject to adjustment are limited to operational parameters thereof including the phase current, the phase voltage, and/or the PWM duty cycle, etc. It is understood, however, that more or less of the parameters of the electric motor 10 may be subject to adjustment if desired. As such, the supervised learning process may include the output of the predictive model (i.e, the predicted output) corresponding to the NVH patterns and/or the anti-noise signals and/or the adjustments to specific parameters of the electric motor 10, whereas the input into the predictive model relates to the input data of the electric motor 10 for which the prediction is being made.

At step 724, the system 100, preferably the computing system 106 and/or the at least one processing device 112, applies the machine learning model to real-time input data of the electric motor 10 to detect and predict the anti-noise signals and/or the adjustments to one or more of the parameters of the electric motor 10 and/or the NVH pattern as indicated by one of the data entries.

At step 726, the system 100, preferably the computing system 106 and/or the at least one processing device 112, generates the anti-noise signals and/or dynamically adjusts specific parameters of the electric motor 10 (e.g., phase current, phase voltage, and/or PWM duty cycle) to minimize torque ripple, harmonics, and/or NVH of the electric motor 10 and/or the electric pump 2.

At step 728, the system 100, preferably the computing system 106 and/or the at least one processing device 112, executes a validation operation.

In some embodiments, regardless of the methodology utilized, the training process may include the training data utilized in forming the predictive model divided into initial training data and validation training data. The initial training data may be utilized to create an initial predictive model configured to make a prediction with respect to at least one of the data entries relating to the anti-noise signals and/or the adjustments to one or more of the parameters of the electric motor 10. The validation training data may then be utilized to make predictions relating to the anti-noise signals and/or the adjustments to one or more of the parameters of the electric motor 10 that can be evaluated relative to the already known data entries relating to such predictions. For example, the data entries of relating to the parameters of the electric motor 10 may be utilized to make a prediction regarding the adjustments to one or more of the parameters of the electric motor 10 as indicated by one of the data entries, wherein the actual value of this data entry is already known from the entirety of the validation training data. In another example, the data entries of relating to the parameters of the electric motor 10 may be utilized to make a prediction regarding the anti-noise signals and/or the adjustments to one or more of the parameters of the electric motor 10 and the NVH pattern as indicated by one of the data entries, wherein the actual value(s) of this data entry is already known from the entirety of the validation training data.

At step 730, the system 100, preferably the computing system 106 and/or the at least one processing device 112, executes a check. In some embodiments, the predicted outcome may be compared to the actual outcome, as indicated in the known validation training data, and the accuracy and precision of the predictive model may then be evaluated based on the training that occurred with respect to the initial training data. Any difference between the predicted outcome and the actual outcome may also be utilized as an error signal for correcting the predictive model according to the corresponding methodology thereof during the validation process.

When the corresponding predictive model is shown to make predictions or determinations having less than a desired degree of accuracy or precision in accordance with the desires of the system 100, the predictive model may be subjected to further training, for example, by repeating steps 722 through 728 as illustrated in FIG. 7. Such data utilized in confirming the predictions of the predictive model may be referred to as the testing training data hereinafter. Such testing training data may accordingly be utilized to further refine the predictions made by the predictive model by evaluating the real-time outcomes of the predictions made by the predictive model.

Alternatively, when the corresponding predictive model is shown to make predictions or determinations having at the desired degree of accuracy or precision in accordance with the desires of the system 100, the predictive model may be deployed at step 732. The trained machine learning program is implemented by the system 100, preferably the computing system 106 and/or the at least one processing device 112, for real-time operation in various desired application, for example, the vehicle.

Effects of system 100 and the method 700 according to the present invention are described below.

First, unlike conventional systems that rely on mechanical clearances, mechanical design, physical sensors, microphones, and mechanical adjustments, the embodiments of the present disclosure detects and measures parameters of the electric motor 10, which is used by a machine learning model to predict the anti-noise signals and/or the adjustments to the one or more of the operational parameters of the electric motor 10, thereby reducing the NVH of the electric motor 10 and/or the electric pump 2.

In some embodiments of the present disclosure, NVH is reduced or eliminated by directly managing the operation of the electric motor 10 (e.g., torque ripple, phase timing, etc.).

Second, the embodiments of the present disclosure utilize a software-driven approach that effectively minimizes NVH in the electric motor 10 and/or the electric pump 2, leading to a quieter and smoother operation.

Third, the embodiments of the present disclosure enhance overall passenger comfort within the vehicle by lowering NVH, contributing to a more pleasant driving and operational experience.

Fourth, the machine learning model utilized in the embodiments of the present disclosure leverages real-time data, allowing for dynamic adjustments in response to ever-changing operating condition, ensuring consistent NVH reduction across various loads and speed, which is lacking in conventional systems and methods.

Fifth, the embodiments of the present disclosure minimize manufacturing and maintenance costs and simplify the overall system architecture by eliminating the need for additional hardware to reduce NVH. Thus, this design solves common issues of complexity found in existing technology and makes it easier to integrate into existing systems.

In some embodiments of the present disclosure, NVH is reduced or eliminated at its source (i.e., the electric motor 10), avoiding reliance on anti-noise sound waves.

Sixth, by eliminating potential points of failure associated with physical sensors, the embodiments of the present disclosure offer increased reliability and durability as well as address concerns prevalent in conventional systems where sensor malfunction can lead to inaccurate readings.

It should be appreciated the system and method according to the present disclosure provides for a novel design for increasing an overall performance, efficiency, and reliability of the electric motor 10 and/or the electric pump 2, while reducing the costs of the components thereof, and thereby the overall costs of the vehicle.

It should be appreciated that the machine learning program may instead rely on a predictive model generated during an unsupervised learning processes described herein without necessarily departing from the scope of the present invention. The present disclosure refers to the use of input data in executing the corresponding machine learning program. Such input data may refer to the parameters of the electric motor 10 detected and measured by one or more of the sensors 110. The input data may be accumulated using any known method so long as the input data is recorded in a form configured for use with the computing system 106 and the corresponding machine learning program executed thereon. The present invention may rely upon the computing system 106 receiving the input data associated with each sensed parameter in order to train the machine learning program and subsequently utilize the predictive model generated thereby. The data set comprising the input data sets of each of the sensed parameter may collectively be referred to as the training data set associated with the machine learning program. The training data set may be organized based on the methodology of the machine learning program utilized in finding relationships between the input data and the NVH patterns the electric motor 10 and/or the electric pump 2.

In some embodiments, the machine learning program may be configured to perform unsupervised learning where the training data set formed by the input data of the sensed parameters is unlabeled with respect to all entries. Each of the different data entries regarding a specific sensed parameter may therefore form an independent unlabeled input for performing the unsupervised learning of the machine learning program.

As used hereinafter, all input data of each sensed parameter that is utilized in training the machine learning program or performing a prediction via the predictive model generated by the machine learning program may alternatively be referred to as the input data profile of the corresponding sensed parameter at the time at which such data is utilized by the machine learning program. The input data profile of the sensed parameter accordingly is different each time the input data regarding the sensed parameter as utilized by the machine learning program changes, such as when certain entries indicate a change in value or a change in state or condition with respect to the input data set of the sensed parameters. The unsupervised training of the machine learning program includes repeatedly adding new data to the training data set regarding the sensed parameters. As more data regarding the sensed parameters is added to the training data set, additional relationships may be discovered within the structure of the data or refinements may be made with respect to already discovered relationships, thereby improving the predictive capabilities of the machine learning program. The training of the machine learning program results in the generation of a predictive model wherein the machine learning program is configured to predict the anti-noise signals and/or the adjustments to the to one or more of the parameters of the electric motor 10 which is expected to be associated with sensed parameters.

It is understood that some embodiments of the present disclosure may use any of the supervised training processes disclosed herein, including the use of a neural network having at least one hidden layer, without departing from the scope of the present invention.

Operations of the methods, and combinations of operation in the methods, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of a system and executed by at least one processor in the system. Any such computer program instructions may be loaded onto a computer or other programmable system (for example, hardware) to produce a machine, such that the resulting computer or other programmable system embody means for implementing the operations specified in the method.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

From the foregoing description, one ordinarily skilled in the art can easily ascertain the essential characteristics of this invention and, without departing from the spirit and scope thereof, can make various changes and modifications to the invention to adapt it to various usages and conditions.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. An electric motor control system using machine learning, comprising:
an electric motor comprising a stator and a rotor; and
a computing system including one or more processing devices in communication with one or more sensors via at least one communication network, the one or more sensors configured to detect and/or measure one or more parameters associated with the electric motor, wherein the computing system executes computer-readable instructions, and wherein, upon execution of the computer-readable instructions, the computing system is configured to:
receive, via the at least one communication network, input data comprising the one or more parameters detected and/or measured by the one or more sensors;
train, via machine learning and using a training data set, a machine learning model configured to identify at least one relationship between the one or more parameters and at least one noise, vibration, and harness characteristic of the electric motor, wherein the training data set utilized during the training of the machine learning model comprises the input data;
predict, via the computing system, an output using the trained machine learning model, wherein the predicted output comprises at least one anti-noise signal and/or at least one adjustment to one or more specific parameters of the electric motor; and
control, via the computing system, the electric motor based on the predicted output to decrease a noise, vibration, and harshness level of the electric motor.

2. The system of claim 1, wherein the machine learning uses at least one neural network.

3. The system of claim 1, wherein the machine learning uses supervised learning.

4. The system of claim 1, wherein the one or more parameters includes a phase current of the electric motor.

5. The system of claim 1, wherein the one or more parameters includes a phase voltage of the electric motor.

6. The system of claim 1, wherein the one or more parameters includes a back-electromotive force of the electric motor.

7. The system of claim 1, wherein the one or more parameters includes a speed of the electric motor.

8. The system of claim 1, wherein the one or more parameters includes a supply voltage of the electric motor.

9. The system of claim 1, wherein the one or more parameters includes a pulse width modulation duty cycle of the electric motor.

10. The system of claim 1, wherein the one or more parameters includes at least one load condition of the electric motor.

11. The system of claim 1, wherein the one or more parameters includes a A-weighted decibel (dBA) of the electric motor.

12. The system of claim 1, wherein, upon execution of the computer-readable instructions, the computing system is further configured to validate the machine learning model.

13. The system of claim 1, wherein, upon execution of the computer-readable instructions, the computing system is further configured to indicate, via a feedback loop, for each predicted output whether the at least one adjustment to the one or more specific parameters decreases the noise, vibration, and harness level of the electric motor.

14. The system of claim 1, wherein the at least one anti-noise signal comprises harmonic cancellation by injecting counter-frequencies in electrical signals.

15. The system of claim 1, wherein the one or more specific parameters of the electric motor are a subset of the input data.

16. The system of claim 1, wherein the one or more specific parameters of the electric motor are limited to operational parameters thereof.

17. The system of claim 1, wherein the one or more specific parameters of the electric motor includes a current and/or a voltage thereof to smooth torque ripple thereof.

18. The system of claim 1, wherein the one or more specific parameters of the electric motor includes a phase timing thereof to decrease a resonance.

19. The system of claim 1, wherein the electric motor is disposed in an electric pump of a vehicle.

20. A method of controlling an electric motor, comprising:
providing an electric motor comprising a stator and a rotor;
providing a computing system including one or more processing devices in communication with one or more sensors via at least one communication network, the one or more sensors configured to detect and/or measure one or more parameters associated with the electric motor, and wherein the computing system is configured to execute computer-readable instructions;
receiving, via the at least one communication network, input data comprising the one or more parameters detected and/or measured by the one or more sensors;
training, via machine learning and using a training data set, a machine learning model configured to identify at least one relationship between the one or more parameters and at least one noise, vibration, and harness characteristic of the electric motor, wherein the training data set utilized during the training of the machine learning model comprises the input data;
predicting, via the computing system, an output using the trained machine learning model, wherein the predicted output comprises at least one anti-noise signal and/or at least one adjustment to one or more specific parameters of the electric motor; and
controlling, via the computing system, the electric motor based on the predicted output to decrease a noise, vibration, and harshness level of the electric motor.
